(19) United States
(12) Patent Application Publication
(10) Pub. No.: US 2014/0082012 A1
(43) Pub. Date: Mar. 20, 2014

(54) METHODS AND SYSTEMS FOR ENHANCED ACCESS TO MULTIMEDIA CONTENTT

(71) Applicants: Padmagowri Pichumani, Bangalore (IN); Padmassri Chandrashekar, Bangalore (IN)

(72) Inventors: Padmagowri Pichumani, Bangalore (IN); Padmassri Chandrashekar, Bangalore (IN)

(73) Assignee: GENERAL INSTRUMENT CORPORATION, Horsham, PA (US)

(21) Appl. No.: 13/619,070

(22) Filed: Sep. 14, 2012

(51) Int. Cl. G06F 17/30

(52) U.S. Cl. 707/769; 707/705; 707/E17.014

(57) ABSTRACT

A Digital Media Server (DMS) is used to manipulate a Content Directory Service (CDS) database operatively connected to a Digital Media Player (DMP), where the DMS hosts multimedia content that a user wishes to be presented on the DMP.

### CROSS-REFERENCE TO RELATED APPLICATIONS

Related subject matter is disclosed in the following patent application, which is commonly owned and co-pending with the present application, and the entire contents of which are hereby incorporated by reference: U.S. application Ser. No. ______, filed herewith, entitled “Methods and Systems for Providing Access to Regions of Interest Within Multimedia Content” (Attorney Docket No. CS39851).

### BACKGROUND

The subject matter of this application generally relates to methods and systems for accessing multimedia content.

Modern electronic devices are often capable of connection to each other in a network through which connected devices may communicate, share data, and otherwise act cooperatively. Such networks frequently interlink devices not only made by different manufacturers, but interlink different types of devices. For example, a network may include any or all of a desktop or laptop computer, a television, an amplifier/receiver, a set-top box, an Internet gateway, a Wi-Fi access point, a printer, and an optical disc player such as a CD, DVD, or Blu-ray player, among many other potentially networkable devices. In order to facilitate the interoperability of devices of varying types and manufactures, industry standards or guidelines have been developed, including Universal Plug and Play (UPnP).

UPnP is a set of protocols by which networked devices discover each others' presence on the network and establish functional services for data sharing and communications. The UPnP standard is designed to enable simple and robust connectivity among networked devices made from many different manufacturers. UPnP allows a device to join a network, obtain an Internet Protocol (IP) address, communicate its capabilities, and discover other devices on the network along with their capabilities. Networked devices can communicate with each other directly, thereby enabling control of networked devices by other networked devices. A UPnP device can be, but does not have to be, a physical device. UPnP uses standard Transmission Control Protocol/Internet Protocol (TCP/IP) and other ubiquitous protocols such as Dynamic Host Configuration Protocol (DHCP), Domain Name System (DNS), and Hypertext Transfer Protocol (HTTP) to facilitate interoperability with existing networks.

Different UPnP devices provide different sets of services. For instance, services within a digital video recorder (DVR) are usually different than those within a printer. Thus, a UPnP device is required to host a device description document, typically written in Extensible Markup Language (XML). The device description document contains the set of services provided by that particular device, as well as pointers such as a Uniform Resource Locators (URLs), which point to service description documents that each correspond to a respective service included within the device description document. The device description may also include vendor-specific manufacturer information including the model name and number, serial number, manufacturer name, URLs to vendor-specific Web sites, and so forth. The description also includes a list of any embedded devices or services, as well as URLs for control of the device.

Each device includes a DHCP client that searches for a DHCP server when the device is first connected to the network. If a DHCP server is available, the device uses the IP address assigned to it. If no DHCP server is available, the device uses Auto IP to get an address. Once devices are attached to the network and addressed appropriately, the device advertises its services to control points on the network, which are devices capable of controlling other devices. The control point can then retrieve the device description and get a list of associated services, retrieve service descriptions for available services, and invoke actions to control the service.

After the control point has retrieved a description of the device, the control point has the essentials for device control. To learn more about the service and device, the control point must retrieve a detailed UPnP description for each service. The description for a service is also preferably expressed in XML and includes a list of the commands that the service responds to, and parameters or arguments for each action. The description for a service also includes a list of variables. These variables model the state of the service at run time, and are described in terms of their data type, range, and event characteristics. To control a device, the control point sends an action request to a device's service. To do this, the control point sends a suitable control message to the control URL for the service that is provided in the device description.

UPnP is used as part of interoperability guidelines adopted by the Digital Living Network Alliance (DLNA), a non-profit, collaborative trade organization. The DLNA guidelines enable sharing of digital media between consumer devices such as computers, printers, cameras, cell phones, and other multimedia devices. These guidelines specify a set of restrictions on public standards, such as UPnP, in order to achieve interoperability of networked devices when accessing, playing, or otherwise managing multimedia over a network. UPnP, for example, defines types of devices supported by the DLNA, e.g. “server,” “renderer,” and “controller,” as well as the mechanisms for accessing multimedia media over a network. The DLNA guidelines then apply a layer of restrictions over the types of media file formats, encodings and resolutions that a device must support.

DLNA certifies home-network devices in a limited set of classes. These classes include a Digital Media Server (DMS), a Digital Media Player (DMP), a Digital Media Renderer (DMR), a Digital Media Controller (DMC), and a Digital Media Printer (DMPr). DLNA also certifies mobile devices in a limited set of classes, generally corresponding to the DMS, DMP, and DMC classes of home-network devices just recited, as well as Mobile Digital Media Up-loaders (M-DMU) and Down-loaders (M-DMD), respectively. In addition, DLNA certifies home infrastructure devices needed to interconnect mobile devices in a home network as well as share multimedia between a mobile device and a home network.

A Digital Media Server (DMS) stores content and makes it available to a networked digital media player (DMP) and digital media renderer (DMR). Examples of Digital Media Servers include PCs, network-attached storage devices such as hard drives, and Digital Video Recorders (DVR). A Digital Media Player (DMP) finds content on a DMS and provides playback and rendering capabilities. Examples of DMPs include televisions, AV receivers/amplifiers, wireless monitors, and game consoles. A Digital Media Printer (DMPr) provides printing services to the DLNA network. A Digital Media Controller (DMC) finds content on a digital media server (DMS) and plays such content on a digital media renderer (DMR) which is typically also a DMP. Examples of DMCs include Internet tablets, Wi-Fi enabled digital cameras and personal digital assistants.

Tens of thousands of DLNA-certified products are available, including televisions, DVD and Blu-ray players, games consoles, digital media players, photo frames, cameras, AV receivers, PCs, and mobile handsets, among many other products. Hundreds of millions of DLNA-certified units have been sold, with accelerating growth predicted.

### BRIEF DESCRIPTION OF THE DRAWINGS

For a better understanding of the disclosure made herein, and to show how the same may be carried into effect, reference will now be made, by way of example, to the accompanying drawings, in which:

FIG. 1 shows an example of a network having Digital Media Server (DMS) devices and Digital Media Player (DMP) devices, where each DMS device is operatively connected to a CDS database of objects accessible through the network.

FIG. 2 shows an example of a first file hosted on a DMS device of FIG. 1, along with a plurality of CDS database objects associated with the first file.

FIG. 3 shows an example of a second file hosted on a DMS device of FIG. 1, along with a plurality of CDS database objects associated with the second file.

FIG. 4 shows an example of a third file hosted on a DMS device of FIG. 1, along with a plurality of CDS database objects associated with the third file.

FIG. 5 shows an example of a fourth file hosted on a DMS device of FIG. 1, along with a plurality of CDS database objects associated with the fourth file.

FIG. 6 shows an example of a method by which a DMS device may implement presentation of CDS database objects shown in FIGS. 2-5.

FIG. 7 shows an example of a navigation hierarchy for browsing media content, where the hierarchy follows the directory structure by which the content is stored.

FIG. 8 shows an example of a first alternative navigation hierarchy for browsing media content, where the hierarchy follows the properties of the content being navigated.

FIG. 9 shows an example of a second alternative navigation hierarchy for browsing media content, where the hierarchy follows the properties of the content being navigated.

### DETAILED DESCRIPTION

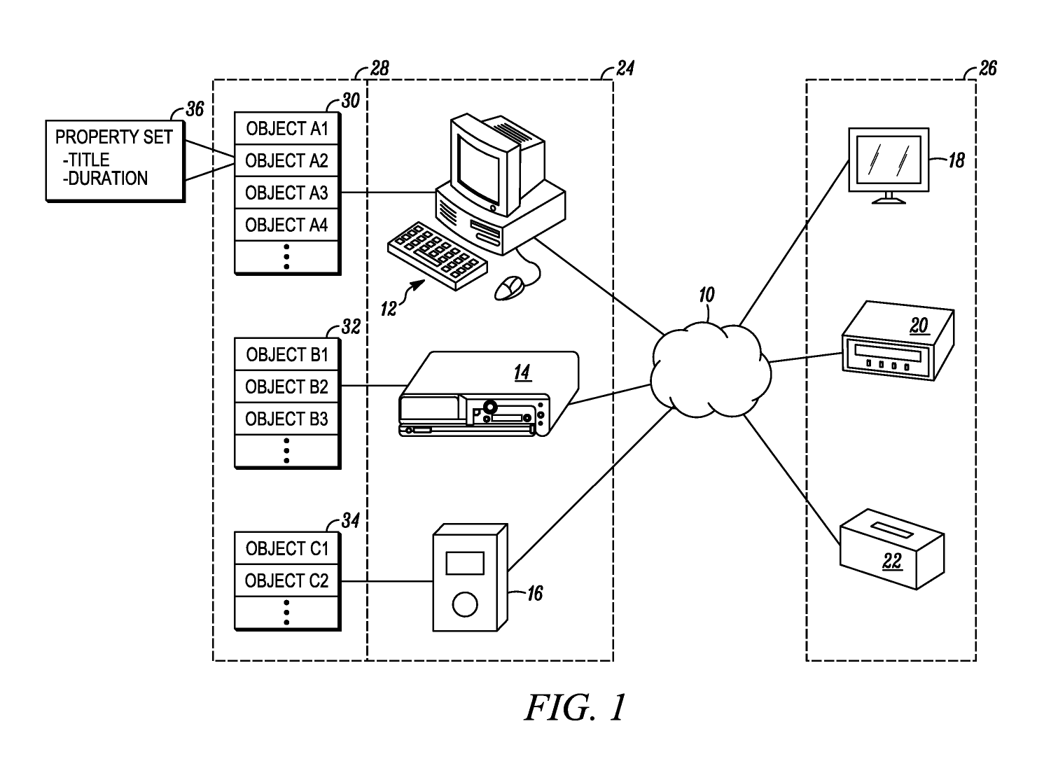

Referring to FIG. 1, an example of a network 10 is illustrated, for use in accordance with an embodiment. Network 10 may interconnect a variety of devices, such as a personal computer 12, a digital video recorder (DVR) 14 which may be incorporated into a cable or satellite set-top box that receives video together with EPG information, a digital media player 16 such as an MP3 player, a television 18, an AV receiver 20, and a printer 22. It should be understood that the devices shown in FIG. 1 are a small representation of the types of devices that could be connected through a network 10. It should also be understood that the networked devices may be interlinked by wired connections, wireless connections, or any combination of the two. The devices contained in the box 24 may each be a Digital Media Server (DMS) in that they each can store digital multimedia files accessible through the network for presentation on selective Digital Media Player (DMP) devices shown within the box 26 of FIG. 1. In this context, a “file” refers to a collection of digital data organized under a single file extension, e.g. .mp3, .wav, .mov, etc., and typically has a file header that defines the boundaries of the file. It should also be noted that many DMS devices may also be DMP devices, e.g. a personal computer or a DVR. Also, unless specifically disclaimed, a DMP device as used in this specification and in the claims, includes a Digital Media Renderer (DMR) device capable of rendering content on a display device.

To facilitate access to multimedia files hosted on any or all of DMS devices 12, 14, and 16 for presentation by a DMP device such as 18, 20, or 22, each DMS device may be operatively connected to a respective Content Directory Service (CDS) database, contained in the box 28 of FIG. 1. For example, the personal computer 12 may be connected to a CDS database 30, the DVR 14 may be connected to a CDS database 32, and the digital media player 16 may be connected to a CDS database 34. Though FIG. 1 shows each DMS device connected to a distinct CDS database, an alternative architecture could provide a master CDS database operatively connected to a plurality, or all, of the DMS devices on the network. As used in this specification and in the claims, a CDS database is one that provides a lookup/storage service that allows a DMP device to locate specific content from among a plurality of content that a DMS device is capable of providing. A CDS database may be used in conjunction with a UPnP device, a DLNA-certified device, or alternatively may be used with a device that is not a UPnP device, is not DLNA certified, or neither. Moreover, a CDS database may be used by a device that is both DMP device and a DMS device to look up content stored by itself.

The CDS database provides a vehicle for a DMS device to advertise the content it can provide to a DMP device over the network 10. For example, the CDS database may advertise a list of songs stored on an MP3 player, a list of images from various slide-shows stored on a desktop computer, a list of movies stored in a DVR, and so forth. Nearly any type of content can be advertised using the Content Directory Service. As seen in FIG. 1, a CDS database may be an organization of objects, such as objects A1-A4 in CDS database 30, objects B1-B3 in CDS database 32, and objects C1 and C2 in database 34. An object may be a data unit (e.g. a digital movie or CD track) stored on a DMS device retrievable by a remote DMP device over a network. The CDS database may then further organize objects into a hierarchy of classes and properties. A class is used to assign a type to an object, such as “audio” or “movie” and may identify the minimum required and optional set of properties present on an object of the specified class. A property represents an attribute of an object.

The class hierarchy may be composed of “items” and “containers.” Items reference individual objects, and are further classified into different types, each of which has a defined set of mandatory and optional properties. Some examples of item classes may be “movie,” “song,” “images,” etc. Containers form the nodes of the CDS hierarchy. They can represent the physical organization of objects or logical collections. Logical collections can have formal definitions of their contents or they can be arbitrary collections. Containers can be either homogeneous, containing objects that are all of the same class, or heterogeneous, containing objects of mixed classes. Containers can also contain other containers, or contain a combination of containers and individual items.

In operation, the CDS databases 30, 32, and 34 permit DMS devices 12, 14, and 16, respectively, to advertise their content over the network in such a manner as to make it accessible over the network for presentation on an appropriate DMP device, such as the television 18, the AV receiver 20, or the printer 22. The appropriate DMP device can access content hosted by a DMS device by initiating a Browse action. The DMS device, on receiving the Browse action for a given container, populates and returns a DLNA content object structure in response to the Browse action. The DLNA content object has all the associated data, such as number of items in that container, along with the item property set for each item in the container. The DMP device uses and manages this information for further navigation and action requests such as playback, pause, rewind, etc.

The item property set contains resource property information, such as the ContentURI, which is used by the DMP device to locate an object within the CDS database. ContentURI (Uniform Resource Identifier) is a standard means to identify a name (URN) or location (URL) of a resource and are used to locate and access those resources within the network 10. The standard URI syntax is defined as follows: <scheme>:://<username>:<password>@<domain>:<port>/<path>/<file>?<querystring>#<fragment>. The content is identified by <path>/<file>. The path and file may refer, for example, to the path of the content in the physical directory structure of the DMS device, while the file may be the filename associated with the stored content.

As an example, referencing the network of FIG. 1, a user of the AV receiver 20 may utilize the procedures just described to browse the CDS database 30 of the desktop computer 24 to find and select a desired object represented in the database, such as a digital music file located on the computer 24. The selected object has a property set 36 including the title of the object and it's location on the DMS device. With this information, the UPnP architecture allows the DMP device to access the desired file for transfer and presentation, and also allows the DMP device to control the DMS device to manipulate the file, if necessary.

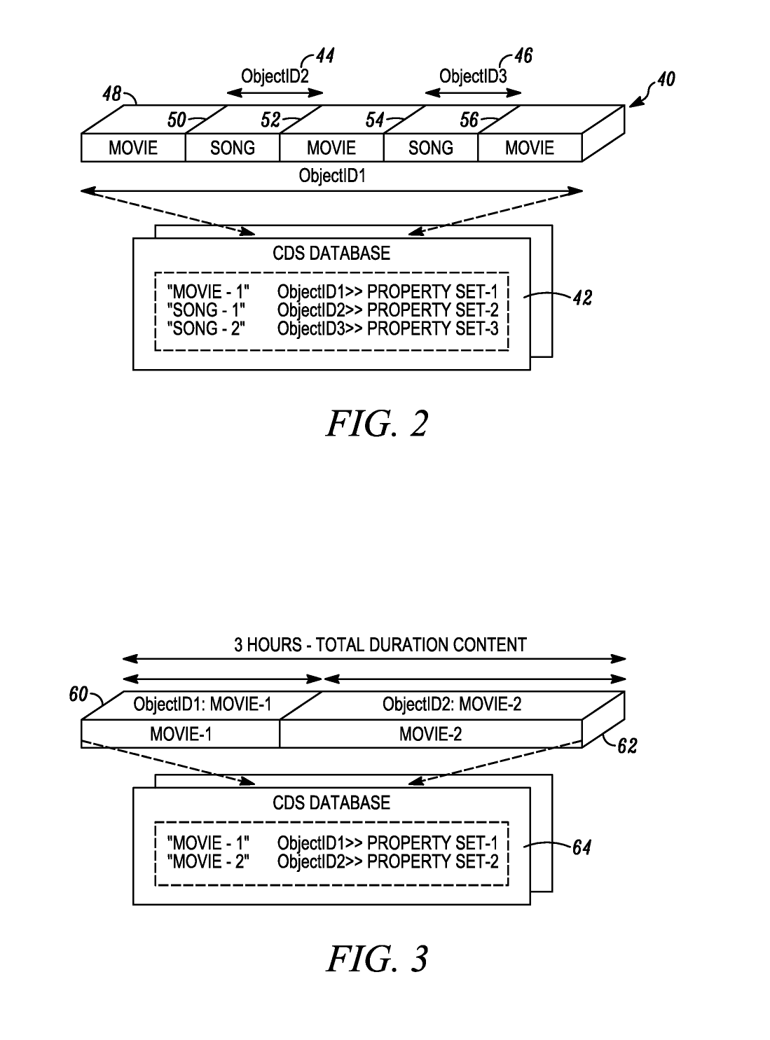

As noted previously, objects in a CDS database may correspond to digital files stored on a DMS device, and selection of these objects through the CDS database permits a DMP device to present the selected file. FIGS. 2-5 illustrate examples of novel architectures, in accordance with embodiments, that permit a CDS database to also specify one of a plurality of manners in which data in a particular file can be presented. Referring first to FIG. 2, a CDS database associated with a DMS device may specifically be configured to allow identification of selective regions of interest within a file hosted on a DMS device, so that those regions of interest may be presented independently of the remainder of the data in the file. Specifically, FIG. 2 shows an object 40, referenced generically in the figure as objectID1, in a CDS database 42 associated with a DMS device such as devices 12, 14, or 16 of FIG. 1. The object 40 may be, for example, a movie file having a first property set defined in the CDS database that specifies statistical information about that movie, e.g. length, title, genre, path and filename, etc.

The CDS database 42 may also include objects 44 and 46, referenced generically as objectID2 and objectID3 respectively. In this example, objects 44 and 46 are each particular songs in the movie of object 40 that a user may want to play independently of the movie. Objects 44 and 46 are each given their own set of properties in the CDS database, such as a title, a media type (e.g. “music” as opposed to the “movie” of which it is a part), musical genre, a path/filename of the file of which it is a part, as well as a reference position within the file, etc. By associating unique objects 44 and 46 in the CDS database 42 with each of these songs, respectively, a DMP device such as an AV receiver 20 of FIG. 1 can play or otherwise present the songs near instantly, without the need for a user to browse through the movie file containing the songs.

To provide such functionality, the property set of the object specifying a region of interest within a file preferably should include a property that identifies the location of the region of interest within the file of which it is a part. One such property could be an “offset pair” that demarcates the beginning and ending points of the region of interest within the file, such as points 50 and 52 demarcating “Song 1” and points 54 and 56 demarcating “Song 2,” measured from a reference location 48 in the file, which could be the beginning of the file, the end of the file, or any other appropriate reference location. Another property in the property set could indicate the number of offset pairs. In one embodiment, to ensure smooth playback of a video file, the first offset of the pair could always point to the key frame (or independently decodable frame) immediately preceding the region of interest. As an alternative, smooth playback/streaming could begin at arbitrary offset locations on the DMS side. Such techniques could include waiting for the next available key frame or starting the streaming of content based on frame refresh with incoming I macroblocks.

The offset pair property can be initially populated within the property set in any one of a number of ways. As one example, the offset pairs can be manually defined by a user using content-editing software modified to permit such demarcations. Alternatively, content that is broadcast over cable or satellite channels often includes metadata associated with movie or television programming, and such metadata may be modified to include for example, songs, actors, etc. that appear in the program along with the frame numbers or other similar locator information within the program in which they appear. As yet another alternative, certain software products are capable of music and other types of content recognition that would be capable of generating such offset data. Still further, any of these techniques may be used to populate other properties within the property set of the object associated with a region of interest, e.g. title, genre, etc.

To present a selected region of interest using the offset pair property, a user of a DMP device such as 18, 20, and 22 of FIG. 1 first utilizes the Browse action to find the appropriate object. Upon selection of that object, the DMP device sends an HTTP “get” request along with the content URI information to the DMS device hosting the desired object. The host DMS device parses the URI information to extract the item identifier within the URI string. Once the item Id is know, the host DMS device searches the CDS database to retrieve the associated properties of the requested Item. The ordered pair of offsets and the number of such ordered pairs would be retrieved. The streaming of the data would then be done starting from each start offset till the corresponding end offset for each ordered pair.

FIG. 3 shows another example of a DMS device, in accordance with an embodiment, configured to allow identification of selective regions of interest within a file hosted on the DMS device. In this instance, a user has recorded content on a DVR, set-top box, or other such recording device such that the recorded item spans multiple programs, depicted as objects 60 and 62, respectively. Each of these objects is represented separately in the CDS database 64 with their own unique property set. In cable broadcast systems, an Event Information Table (EIT) is transmitted that contains all the properties of the current event/program. This includes metadata like Title, Actor, Director. An EIT also typically has the start time and end time of each event. By monitoring the event start and end times, during the course of a recording, the DMS device, e.g. DVR, can demarcate each event or program using, for example, an offset as described in the preceding paragraphs, and can store metadata associated with each program separately. The single recording can then be viewed by accessing devices, as two distinct objects. The retrieved metadata may also indicate whether the complete program is available or not. Were specific access to the region of interest not available, then when a browse action was initiated by a DMP device, the DMS device would return a property set associated with only one of the multiple programs recorded. It should be understood that, rather than populating the property sets of the respective objects 60 and 62 with data retrieved from an EPG, other suitable techniques may also be used, e.g. user-entry, etc. It should also be understood that the foregoing procedure could be extended to demarcating more than two programs within a recorded segment on a DVR.

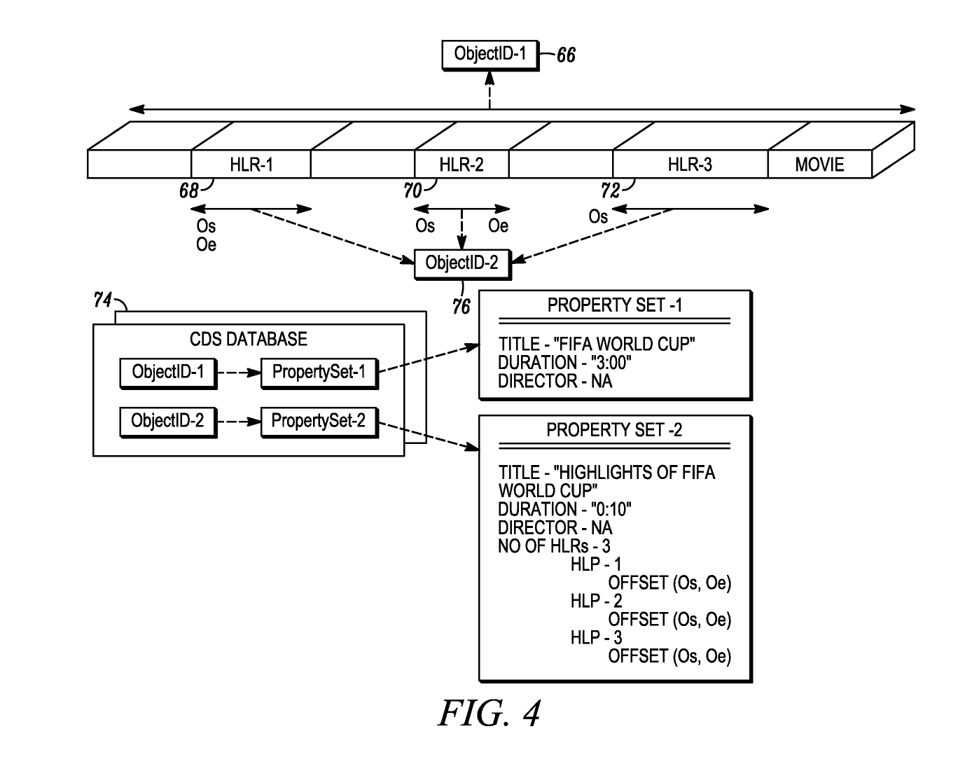

FIG. 4 shows another example of a DMS device, in accordance with an embodiment, configured to allow identification of selective regions of interest within a file hosted on the DMS device. In this instance, a CDS database 74 may store an object 66, denoted in this figure as ObjectID-1, which represents for example, a stored broadcast of soccer match. The CDS database may also store, as a unique object 76, user generated highlight segments 68, 70, and 72 which each comprise separate segments of the entire program. Similar to the procedure described earlier with respect to FIG. 2, these user-generated highlight segments may be denoted by respective pairs of offsets. With respect to this example, however, the series of offset pairs defining the segments is associated with a single object in the CDS database, with a single property set. Thus, in this instance, the object 76 is a user-defined summary of program highlights, where the object 76 includes within its property set a sequence of offset pairs that demarcate the segments included in the summary. Selection and playback of the summary through the CDS database may proceed in the same manner as described with respect to FIG. 2.

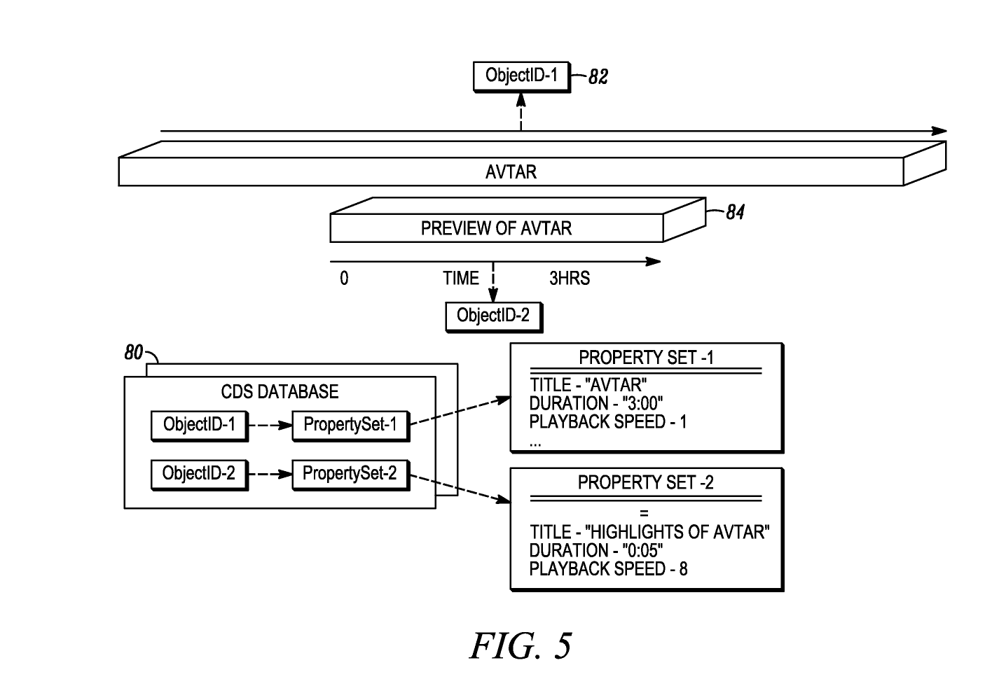

FIG. 5 shows an example of a DMS device, in accordance with an embodiment, configured to allow identification of an automatically generated quick-preview of a program using a novel item property of a streaming rate, which may be expressed as a “playback speed,” “playback rate,” or any other desired title. This property provides access to a quick preview for any object in the CDS database. As seen in FIG. 5, a CDS database 80 includes two objects 82 and 84, respectively, where each object represents a program, such as a movie. One object, however, such as object 84, can be used to reference the content in a quick preview mode where the property set for that object defines a streaming rate greater than 1, while for object 82 (or other objects associated with the program such as a user-defined summary of FIG. 4, or songs of FIG. 2, etc.) the streaming rate property may be set to 1. When a HTTP “get” request, following a CDS playback option, is triggered by the DMP device, the DMP device will retrieve the streaming rate property and stream the content accordingly.

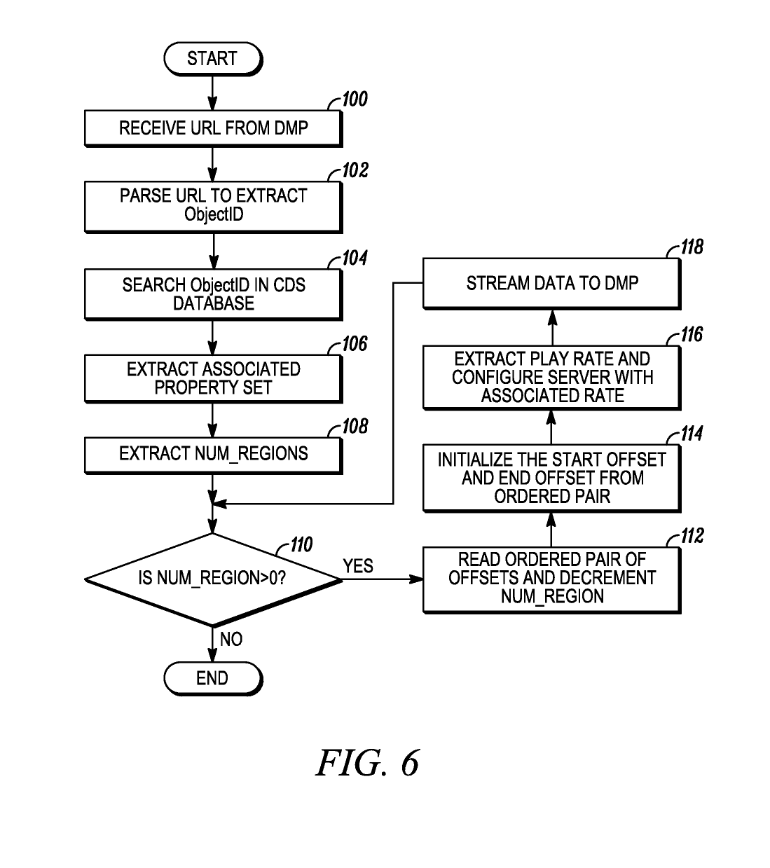

FIG. 6 illustrates an example of a method, in accordance with an embodiment, by which a DMS device may use the item property defining offset pairs to present content such as a summary of FIGS. 4 and 5, or other regions of interest like the examples of songs of FIG. 2 or the individual movies of FIG. 3. Initially, the DMS device may receive ancillary data, such as a URL, from a requesting DMP device in step 100. The DMS device then parses the received URL to extract the object ID associated with the desired content in step 102. In step 104, the DMS device uses the property set of the object associated with the extracted object to search the CDS database for the extracted object ID. Once found, the DMS device extracts the property set associated with that object ID in step 106. In step 108, the DMS device uses the property set of the object to further extract a property defining the number of regions of interest associated with the object, which will typically be the number of ordered pairs in the property set, where each object would typically include at least one ordered pair, i.e. a program with only one ordered pair would simply demarcate the beginning and ending of the program in its entirety. In step 110, the method checks to ensure that the number of ordered pairs is greater than zero. If so, the method proceeds to step 112 to read the next sequential ordered pair defined in the property set of the extracted object, and then decrements the number of ordered pairs read in step 108 by one. In step 114 the start offset and end offset are initialized from the ordered pair read in step 112. In step 116, the streaming rate is extracted from the property set and the DMS device is configured with the appropriate rate. In step 118, the data for the ordered pair read in step 112 is streamed to the DMP device at the appropriate rate. At this point, the method loops back to step 110 where another check is made to see whether the decremented number is greater than zero. If so, steps 112 to 118 repeat until the decremented number is zero, at which point the process stops. It should be understood that this method may be readily modified, in circumstances where objects can be referenced by a single offset, as opposed to a pair of offsets—e.g., where the only regions of interest share a common beginning or ending point, to read a single offset rather than an offset pair.

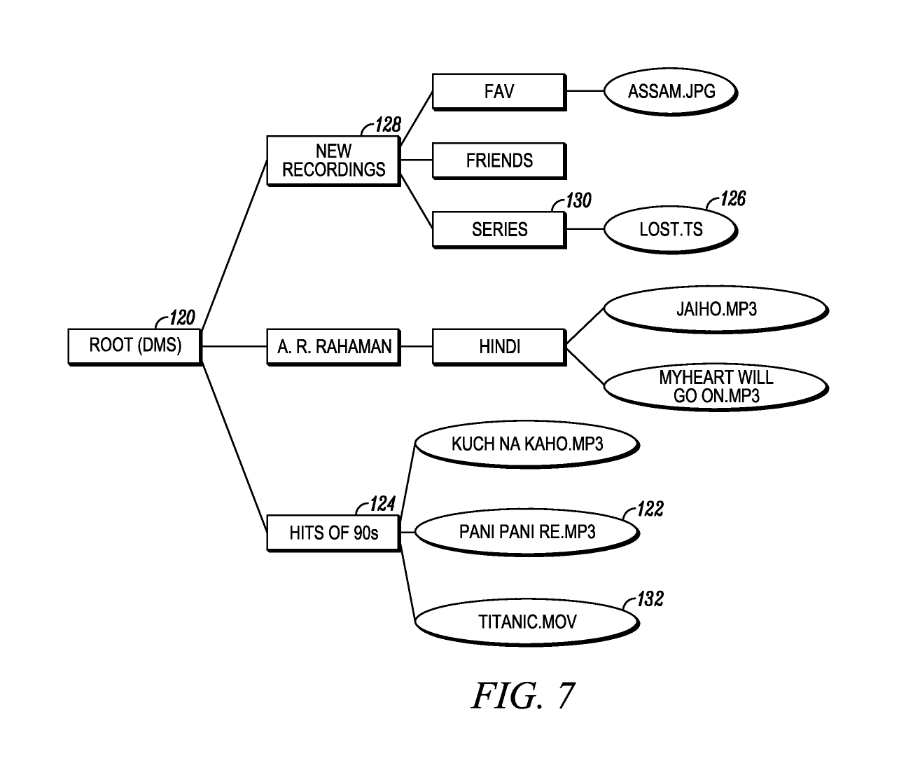

FIGS. 2-5 illustrate examples of novel architectures, in accordance with embodiments, where more than one object in a CDS database may reference a single file hosted by a DMS device, yet have different property sets. This architecture may highlight difficulties presently encountered when a user of a DMP device browses a CDS database for desired content. Specifically, existing techniques for browsing multimedia content hosted on a DMS use hierarchies that closely follow the directory structure of the file system storing that content, and in fact usually have a direct one-to-one mapping with the directory structure in the storage media. FIG. 7 illustrates an example of such a hierarchy, based on a directory structure, where a user stores media files of a plurality of different types, e.g. music files, movie files, still images, etc. In this directory structure, the content is discovered from the root directory 120 of the host DMS device by navigating through a series of arbitrarily-named folders and sub-folders. As one example, if a user wanted to present the audio file “Pani Pani Re” 122 on a DMP, the user would navigate from the root directory 120 to the folder 124, named “Hits of the 90s” (which likely could represent an album and have been created from default settings of audio-burning software), and then could select the desired audio track 122. Alternatively, should a user wish to present the file Lost 126, the user would navigate from the root directory 120 to the folder 128 named “New Recordings” to the folder 130 named “Series,” and then could select the desired file 126.

As can be seen in this example, navigating a hierarchy that follows a directory tree structure is efficient only if the user organizes data in a very methodical manner. For instance, some content may be erroneously located in the wrong folder, such as the movie “Titanic” 132 in the album folder “Hits of the 90s” 124, in which case a user would need to traverse through this structure back and forth multiple times to locate the desired movie, wasting much time. Moreover, even if a user's content were organized carefully and methodically, the user can glean only a minimal amount of information from the hierarchy. For instance, if a user were to know the name of an audio track, but did not know the artist or album, or any other relevant information, the user would still have to engage in a time-consuming process to locate the desired file.

These difficulties with existing hierarchies are exacerbated if, as is shown in FIGS. 1-5, a single file archived in a database may be associated with plural objects, such as a home recording spanning two movies, and particularly if different objects associated with a file represent different types of content, e.g. a song within a movie. In such circumstances, it may not be possible for a user to carefully organize data in a directory tree format so that the directory tree can be intuitively navigated to desired content.

As an alternative, a user of a DMP device may choose to find desired content using actions such as “Search” or “FreeFormQuery.” A “Search” action allows the calling DMP device to search the CDS database for objects that match some search criteria, typically properties present in metadata of content archived in the database. In some instances, a “Search” action may also allow a database to be searched using a string containing multiple properties connected in a logical operation, such as Boolean “AND,” “OR,” etc. operators. A FreeFormQuery action allows a calling DMP device to specify a class and a property. Upon receipt of that query, a DMS device returns objects that match the queried class and property. For example, if a FreeFormQuery from a DMP device to a DMS device specifies the class of “audio” and the property of “titles,” the DMS device will return a list of titles of audio items. As another example, if a FreeFormQuery specifies the class of “audio” and the property of artist, we can get a list of all artists for all the audio items.

Unfortunately, many DMP devices do not support either the Search action or the FreeFormQuery action. The UPnP standard, for example, lists both of these actions as merely optional, the only mandatory actions being the Browse action, GetSystemUpdateID action used to determine changes in the CDS database, and certain actions returning capabilities of the DMS device. Thus, in such DMP devices, using a “Browse” action to navigate a native file directory hierarchy will often prove frustrating.

The present inventors, however, devised a technique that permits a DMS device to emulate at the server such features as the Search and FreeFormQuery actions, which may not be supported by a DMP device, using no more than a Browse action received from a DMP device. In this manner, a user of a DMP device that supports only mandatory actions as specified by the UPnP standard may nonetheless implement optional actions, and may therefore be able to find desired content in a CDS database in a much more timely and intuitive manner.

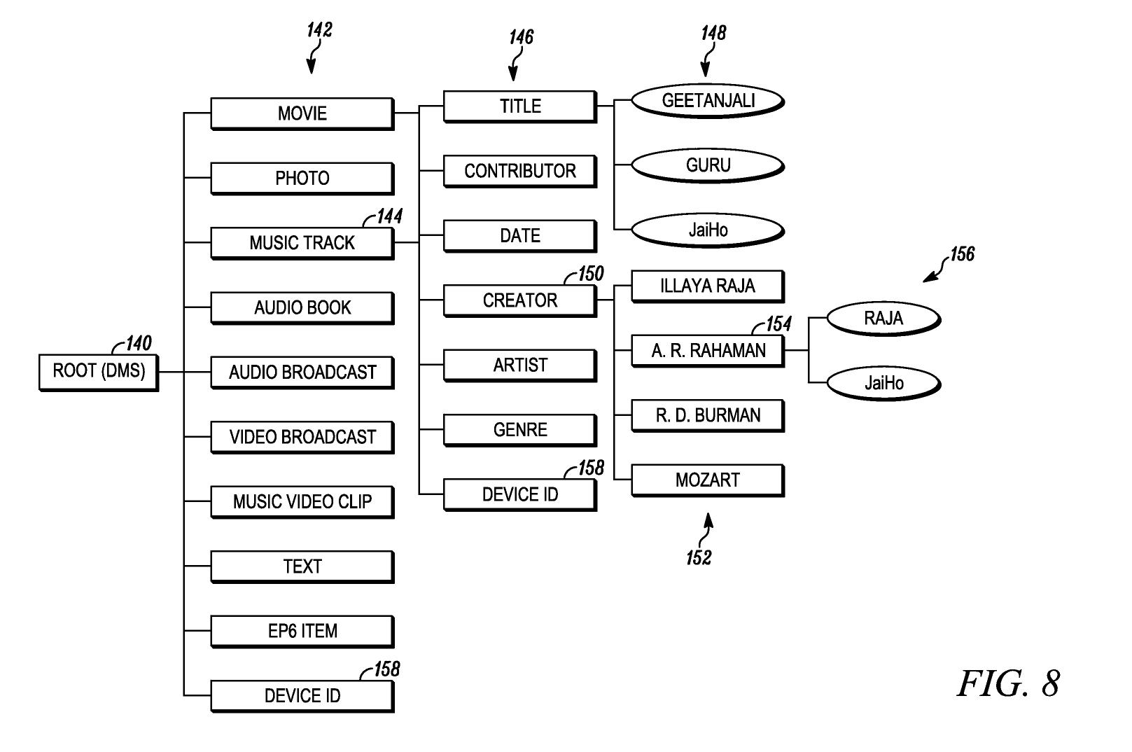

FIG. 8 illustrates an example of such an improved technique, in accordance with an embodiment, that may be used by a DMS device such as the devices 12, 14, and 16 of FIG. 1. Upon receipt of a Browse action given by a DMP device, a DMS device may return a navigable hierarchy of objects which is based on the class and property metadata found in the archived content, instead of one based on the directory structure of the archived content. Preferably, the class and property metadata upon which the navigable hierarchy is based may include intrinsic properties of the content archived by the CDS database being navigated. The term “intrinsic” refers to the attributes of the content itself, such as a title, genre, type of content such as movie or text or photo, author, file size or other measure of length such as track time, whether the content is copyrighted or copy protected, etc. The term “intrinsic” does not refer to the location at which the content is stored, e.g. a file directory path, or a device upon which the content is located, etc. It should be understood, however, that the navigable hierarchy disclosed in FIG. 8 may also incorporate location properties of media content, in addition to intrinsic properties as just defined. For example, at one or more levels of the hierarchy, the user may be presented with a “DeviceID” selection that allows a user to limit further navigation to those objects hosted on a particular device. Additionally, this concept can be expanded to give users the opportunity to limit further navigation to particular drives on a device, folders on a drive, etc. Such options may be beneficial, for example, where DMS devices are used by multiple people with segregated media content and a user wants only to navigate among their own content.

The navigable hierarchy of FIG. 8 may be used by a user to emulate such features as a Search action and a FreeFormQuery action, using the browse action that instantiates the navigable hierarchy. Specifically, once a DMP device initiates a browse action upon the root directory 140 of a receiving DMS device, the DMS device may return and display a list 142 of top-level classes archived by the CDS database, typically representing the types of content that the CDS database is capable of archiving. For example, as shown in FIG. 8, the top-level classes could include the “Movie” class, the “Photo” class, the “MusicTrack” class, the AudioBook” class, the “AudioBroadcast” class, the “VideoBroadcast” class, the “MusicVideoClip” class, the “Text” class, and the “EPGItem” class. A user may then continue to use the Browse action to construct a desired search or query by navigating the hierarchy, by for example, selecting the “MusicTrack” class 144 or another desired class of content. Upon such a selection, the DMS device returns and displays a set of properties 146 associated with the selected content class, containing for example, the “Title” property, the “Contributor” property, the “Date” property, the “Creator” property, the “Artist” property, the “Genre” property, and/or any other property associated with the selected class 144 in the CDS database, such as album, etc. Continuing in this fashion, upon selection of a displayed property using a Browse action, the DMS device may return and display either a list of objects such as 148 if the CDS database directly associates such objects with the selected property, or may return and display a second property set 152 which may ultimately be navigated to an object set such as 156 by, e.g. selection of a property 154 in the property set 152.

As can be seen from FIG. 8, by receiving and implementing successive signals in a Browse action received from a DMP device, a DMS device may emulate such advanced actions as a Search action or a FreeFormQuery action. For example, if a user desired to use a Search action in the CDS database for music tracks by A. R. Rahaman, but was using a device that lacked the Search action, the user could nonetheless navigate the hierarchy shown in FIG. 8 to emulate the desired search by successively navigating to, and selecting, MusicTrack 144, Creator 150, and A. R. Rahaman 154. Similarly, if a user desired to use a FreeFormQuery action in the CDS database to obtain a list of content of the class MusicTrack and the property “Creator” to obtain a list of artists available, but lacked the FreeFormQuery action, the user could nonetheless navigate the hierarchy shown in FIG. 8 to emulate the desired FreeFormQuery by successively navigating to, and selecting, MusicTrack 144 and Creator 150.

It should be recognized that, although FIG. 8 illustrates the example of a navigable hierarchy in a tree structure, the implementation of the navigable hierarchy can display it to a user in any appropriate fashion, which may or may not display a tree-like relationship between successive levels of the hierarchy. For example, upon selection of a desired class/property, a user may simply be presented with a replacement menu showing the next navigable list in the hierarchy. Alternatively, an appropriate interface may use drop-down menus, scroll windows, or any desired GUI.

The classes 146, as well as the property sets 146, 152 and the object sets 148 and 156 may be returned in any appropriate manner. As one example, the DMS device may store the hierarchy structure in memory prior to a user requesting navigation, to save computation resources. Preferably, however, the hierarchy shown in FIG. 8 may be dynamically constructed as a user browses it, so that the user's browsing actions are contemporaneously used to develop the hierarchy, such that information presented to the user in successively-displayed levels of the hierarchy are not pre-stored in memory prior to the DMS device receiving a signal browsing to that displayed level. As one example, when a user of a DMP device initiates a browse action to display the class list 142, the DMS device may search the content in the CDS database to populate respective containers, associated with the classes in the list with those objects falling within the appropriate class, and contemporaneously discover and indicate which type of content is in the CDS database. This could be accomplished by, for example, graying out or otherwise denoting classes for which there is no associated content in the database, or perhaps simply omitting the display of any class for which there is no associated content in the database. Such procedures could also be used with respect to the property list 146, or any other list to which a user navigates.

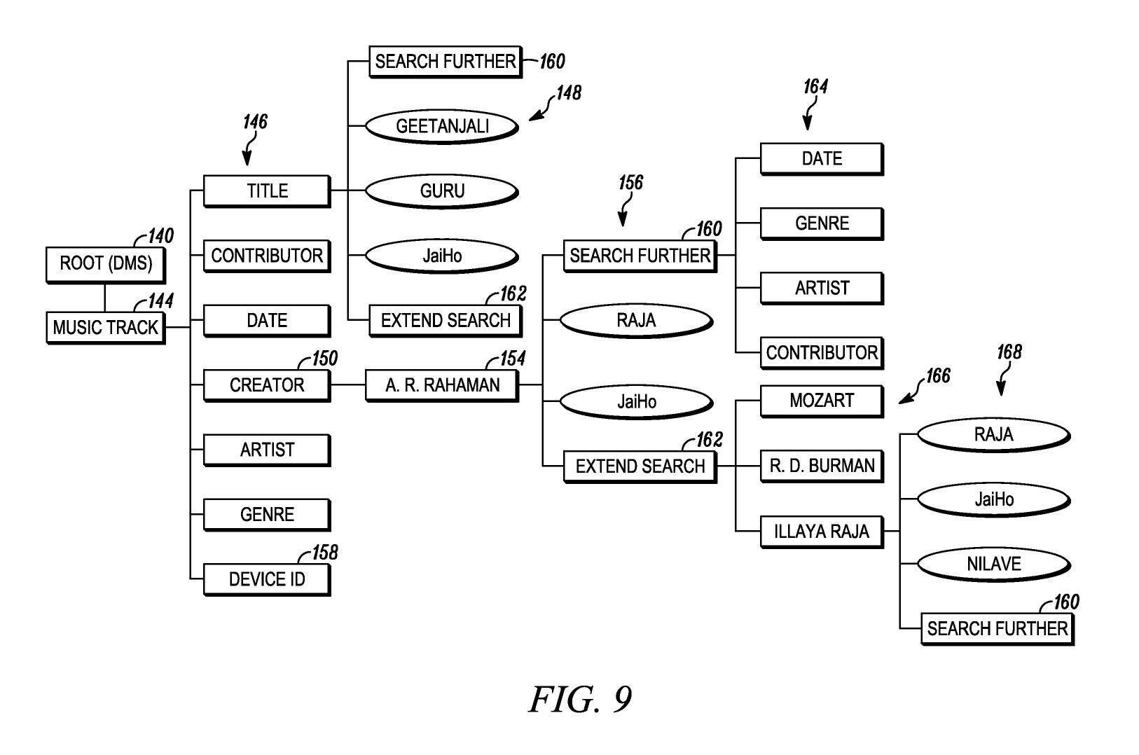

FIG. 9 shows an example of another navigable hierarchy, similar to that of FIG. 8, but including several alternative features, in accordance with an embodiment, by which a navigable, content-based hierarchy may be dynamically constructed using contemporaneous input from a user. Specifically, a navigable hierarchy may optionally include one or more “search further” selections 160, one or more “extend search” selections 162, or both of these types of selections. In the embodiment illustrated by FIG. 9, for example, both the “search further” selection 160 and the “extend search” selection 162 are made available whenever navigation of the hierarchy has proceeded to a level that presents a list of objects, such as the lists 148, 156, and 168. It should be understood, however, that other variations are possible, such as presenting only a “search further” selection when displaying objects stemming from some selections, such as “Title,” while presenting both the “search further” selection 160 and the “extend search” selection 162 when displaying content stemming from other selections. Still further, the “search further” selection 160 and the “extend search” selection 162 may be presented in other lists such as the property lists 146 and/or 164, or the lists 142 or 152 of FIG. 8.

As can easily be appreciated from FIG. 9, a user may navigate the hierarchy to construct complex Boolean searches of content. For example, a user can implement a music search for an artist of A. J. Rahaman AND a specific date (or some other property of an object) by navigating from the root menu 140, to the music track selection 144, to the Creator selection 150, to the A. J. Rahaman selection 154, then when presented with the list 156 selecting the “Search Further” selection 160, after which the user is presented with a list 164 of additional object properties, including Date, Genre, etc. through which a user may add an additional search criteria. Thus, the hierarchy of FIG. 9 permits a user to emulate a Boolean “AND” search of multiple object properties from the same hierarchical level, using nothing more than a browse action.

Similarly, the hierarchy of FIG. 9 may be used to emulate a Boolean search of, for example, of musical tracks by the creator A. J. Rahaman OR the creator Illaya Raja by navigating from the root menu 140, to the music track selection 144, to the Creator selection 150, to the A. J. Rahaman selection 154, then when presented with the list 156 selecting the “Extend Search” selection 162, after which the user is presented with a list 164 of additional Creators. Upon selecting Illaya Raja, the user will then view a list of tracks in the navigated CDS database created by either A. J. Rahaman or Illaya Raja. At this point, if desired, the user may even elect to select the “Search Further” selection 160 to include an additional “AND” term in the emulated search.

Even more extensive search options may be enabled by the disclosed methods and systems. For example, a DMS device such as devices 12, 14, and 16 of FIG. 1 can manipulate a CDS database to create a container and associate any objects/item in the database with that container. Thus, an implementation of the disclosed “search further” and “extend search” features could allow very complex Boolean searches that combine nearly any object type and property in any combination of AND or OR operations. For example, when a user selects an “extend search” button, a DMS device could create a temporary container and associate with that container all objects that the user has already navigated to, then reset the user to the beginning of the hierarchy to start navigation anew, and when the user navigates to a new set of objects, retrieve those objects from the “results” folder to display along with the new set of objects. In this way, navigation of a hierarchy using only a Browse action could construct a complex search of, for example, [(Music AND Artist AND Rahaman) OR (Movie AND Creator AND Polanski AND Date AND 1992)], to find either music by Rahaman or movies by Polanski that were made in 1992.

It will be appreciated that the scope of the disclosure is not restricted to the particular embodiments that have been described, and that variations may be made therein without departing from the scope of the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method comprising:
receiving at a Digital Media Server (DMS) at least one signal from a digital media player (DMP); and
automatically processing said at least one signal to navigate among a plurality of content based on at least one intrinsic attribute associated with at least one of a plurality of files accessible to said server, wherein said content is navigated using a dynamically constructed hierarchy.

2. The method of claim 1 wherein information about a storage location of the files is not used in constructing the hierarchy.

3. The method of claim 1, where said hierarchy is dynamically constructed using an arbitrarily selected combination of said intrinsic attributes.

4. The method of claim 1, where navigation is used to construct said hierarchy.

5. The method of claim 1 including automatically processing said at least one signal to navigate among said plurality of content based on a storage location of media content.

6. The method of claim 1 where each said at least one signal is a mandatory Content Directory Service (CDS) action.

7. The method of claim 6 where each said CDS action is a Browse action.

8. A method comprising:
receiving at least one signal from a Digital Media Player (DMP), each said at least one signal being a first Content Directory Service (CDS) action; and
automatically processing said at least one signal to emulate a second CDS action.

9. The method of claim 8 where each processed said signal is a Browse action.

10. The method of claim 9 where the emulated said CDS action is one of a Search action and a FreeFormQuery action.

11. The method of claim 8 where the emulated said CDS action is one of a Search action and a FreeFormQuery action.

12. The method of claim 8 where said step of automatically processing said at least one signal is performed by a Digital Media Server (DMS) and comprises using the received said at least one signal to dynamically generate a navigable hierarchy of file attributes.

13. The method of claim 12 where said navigable hierarchy is generated using metadata associated with content accessible to said DMS.

14. The method of claim 8 where the received said at least one signal is processed to dynamically populate a CDS container, where said CDS container is not populated prior to receipt of said at least one signal.

15. A system capable of processing a signal received from a Digital Media Player (DMP), said system comprising:
storage that stores a plurality of content, each of said content having associated metadata descriptive of its intrinsic attributes; and
a processor operatively connected to said storage and capable of using said signal to navigate a hierarchy of said intrinsic attributes, said hierarchy dynamically constructed using said metadata.

16. The system of claim 15 where navigation of said hierarchy by a user enables a Boolean search of said content by selective said intrinsic attributes.

17. The system of claim 16 where said Boolean search comprises at least one of an “AND” operation and an “OR” operation.

18. The system of claim 16 where each said intrinsic attribute may be selectively combined with any other said attribute in said Boolean search.

19. The system of claim 16 where said Boolean search may be performed using only a Browse action.

20. The system of claim 15 where navigation of said hierarchy is used to define a next level of said hierarchy.
